(19) United States
(12) Patent Application Publication
(10) Pub. No.: US 2024/0403130 A1
(43) Pub. Date: Dec. 5, 2024

(54) SETTING RESOURCE REQUESTS AND LIMITS IN A CONTAINER HOSTING ENVIRONMENT

(71) Applicant: Verizon Patent and Licensing Inc., Basking Ridge, NJ (US)

(72) Inventors: Myron E Bagwell, Southlake, TX (US); Kent S Gordon, Forth Worth, TX (US)

(21) Appl. No.: 18/203,733

(22) Filed: May 31, 2023

(51) Int. Cl. G06F 9/50; G06F 8/60

(52) U.S. Cl. CPC G06F 9/5055; G06F 8/60

(57) ABSTRACT

One or more computing devices, systems, and/or methods are provided. In an embodiment, a method includes hosting a first application within a first container of a container hosting environment. A first peak resource usage for the first application is acquired. A first resource request is determined for the first application based on the first peak resource usage. A first resource limit for the first application is determined based on the first peak resource usage. An entity in the container hosting environment is redeployed based on the first resource request and the first resource limit.

### BACKGROUND

Applications have been traditionally designed to execute within operating systems of computing devices, such as desktop computers, laptops, tablets, mobile devices, servers, or other types of computing devices. The operating system may manage the lifecycle of an application executing on a computing device. The operating system may provide the application with access to memory resources, storage resources, processor resources, network resources, and/or other resources of the computing device. The application may have little to no restrictions on resource utilization due to an expectation that resource utilization will be managed by the operating system execution environment, and any resources needed will be made available. Thus, the application may not be designed for optimal resource utilization.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram illustrating an example a container-hosting environment.

FIG. 2 is a flow chart illustrating an example method for setting resource request and limits within a container hosting environment.

FIG. 3 is a diagram illustrating dynamic control of resource requests.

FIG. 4 is an illustration of a scenario featuring an example non-transitory machine readable medium in accordance with one or more of the provisions set forth herein.

FIG. 5 is an illustration of example networks that may utilize and/or implement at least a portion of the techniques presented herein;

FIG. 6 is an illustration of a scenario involving an example configuration of a computer that may utilize and/or implement at least a portion of the techniques presented herein;

FIG. 7 is an illustration of a scenario involving an example configuration of a client that may utilize and/or implement at least a portion of the techniques presented herein;

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of computing scenarios in which the disclosed subject matter may be utilized and/or implemented.

One or more systems and/or techniques for application deployment, monitoring, and management within a container hosting environment are provided. Many applications are defined for execution by an operating system of a computing device, such as a data center server, desktop computer, a laptop, a tablet, a mobile device, or some other computing device. These applications may utilize CPU, threads, memory, I/O, and/or storage of the computing device during execution. However, the applications may utilize these resources in suboptimal ways because the applications were designed without expectations of restrictions on resource access and usage. Instead, the applications were designed to expect a high level of resource availability, which would be managed by the operating system computing environment.

According to some embodiments, a method includes hosting a first application within a first container of a container hosting environment, acquiring a first peak resource usage for the first application, determining a first resource request for the first application based on the first peak resource usage, determining a first resource limit for the first application based on the first peak resource usage, and redeploying an entity in the container hosting environment based on the first resource request and the first resource limit.

According to some embodiments, a computing device comprises one or more processors configured to host a first application within a first container of a container hosting environment, acquire a first peak resource usage for the first application, determine a first resource request for the first application based on the first peak resource usage, determine a first resource limit for the first application based on the first peak resource usage, and redeploy an entity in the container hosting environment based on the first resource request and the first resource limit.

According to some embodiments, a non-transitory computer-readable medium storing instructions that when executed facilitate performance of operations comprises hosting a first application within a first container of a container hosting environment, acquiring a first peak resource usage for the first application, determining a first resource request for the first application based on the first peak resource usage, determining a first resource limit for the first application based on the first peak resource usage, and modifying a configuration of an entity for hosting the entity in the container hosting environment based on the first resource request and the first resource limit to generate a modified configuration.

It may be useful to transition from hosting applications (legacy application) within traditional operating systems to hosting the applications within a “webscale” or “cloud-scale” hosting environment, such as using containers as execution environments and using management and orchestration systems (e.g., Kubernetes) for execution management, to take advantage of the cloud-based and scalable application infrastructure of these environments. Unfortunately, many of these applications are not configured to take advantage of the scalability of the infrastructure provided by the webscale hosting platform. Using a container-based hosting environment as an example, when an application is to be run, a container managed by a pod is deployed using a configuration (e.g., a manifest) defining resource allocations, limits, and/or other parameters relating to the execution of the application. The existing resource allocations, limits, and/or other parameters may not be an efficient allocation for hosting the application, which can result in overprovisioning and/or under provisioning of resources. For example, in a traditional application operating environment, application scalability was generally achieved by overprovisioning resources so that the application could access the additional resources during times of additional demand. In a container-based environment, however, these demand events are typically handled by deploying additional application instances, which reduces the need for such overprovisioning. Additionally, these applications may not be designed for fast application startup expected by the containerized infrastructure when new application instances are deployed, which reduces the ability to scale quickly to address demand. Further considerations may include how external communication with other applications are configured, and whether various application artifacts such as files may exceed the processing capabilities of the container hosting platform.

When Kubernetes schedules a pod for hosting one or more containers, it is important that the pod has enough resources, CPU and memory, to actually run. If a large application is scheduled on a node with limited available resources, the node may run out of memory or CPU resources resulting in restriction or termination of the pod. Applications may consume excess resources by spawning more replicas than are needed, by implementing a configuration change that causes a deployment to use 100% of an available resource, or by overstating how many resources are actually needed to run the pod or container. In some instances the resource needs of an application hosted by a container may be unknown, such as when an application is first migrated to a container hosting environment. Under-requesting of resources can lead to platform capacity shortfalls, while over-requesting of resources can lead to higher cost of acquisition, higher operating cost (power, hardware, licensing fees, etc.), and underutilization of the platform resources.

Accordingly, as provided herein, a system 100 is provided for dynamically setting requests and limits in a container hosting environment 102, in accordance with some embodiments. The container hosting environment 102 comprises a cluster controller 104 for managing one or more clusters 106, an infrastructure manager 108, an infrastructure configuration repository 110, a metric collector 112, a data store 113, and a resource adjustor 114. In some embodiments, the cluster 106 comprises one or more nodes 116 that provide computing resources to pods 118 that host containers 120 for applications 122. A cluster 106 uses the nodes to run containerized applications. For example, a pod 118 may host one or more containers 120, and each container 120 may host one or more applications 122. A cluster 106 allows the containers 120 to run across multiple machines and environments: virtual, physical, cloud-based, and on-premises. The nodes 116 can be physical computers or virtual machines. In some embodiments, the container hosting environment 102 uses Kubernetes as a management and orchestration platform using a GIT topology for managing infrastructure. The infrastructure manager 108 may be a GITOps manager that manages infrastructure using configurations (manifests) stored in the infrastructure configuration repository 110, which may be referred to as a GIT REPO. The cluster controller 104 operates lie a control loop that monitors the shared state of the cluster 106 and makes changes to attempt to move the current state towards a desired state, such as by replicating or terminating containers 120. In Kubernetes, containers 120 may assigned to namespaces, which are virtual sub-clusters.

Applications hosted within multiple containers 120 may interact with one another and cooperate together. For example, an application 122 within the container 120 may access another application within other containers managed by the pod 118 to access functionality and/or services provided by the other application. The container hosting environment 102 may provide the ability to support these cooperating applications as a grouping managed by the pod 118. This grouping (pod) can support multiple containers 120 and forms a cohesive unit of service for the applications 122 hosted within the containers 120. Containers 120 that are part of the pod 118 may be co-located and scheduled on the same node 116, such as the same physical hardware or virtual machine. This arrangement allows the containers 120 to share resources and dependencies, communicate with one another, and/or coordinate their lifecycles of how and when the containers 120 are terminated.

In some embodiments, the pod 118 may run and manage containers 120 from the perspective of the container hosting environment 102. The pod 118 may be a smallest deployable unit for computing resources that can be created and managed by the container hosting environment 102. The pod 118 may support multiple containers 120 and forms a cohesive unit of service for the applications hosted within the containers, such as the application 122 hosted within the container 120. That is, the pod 118 provides shared storage, shared network resources, and a specification for how to run the containers 120 grouped within the pod 118. For example, the pod 118 may manage multiple co-located containers that share resources. These co-located containers form a single cohesive unit of service provided by the pod 118. The pod 118 wraps these containers 120, storage resources, and network resources together as single unit that is managed by the container hosting environment 102.

A configuration may be specified for an individual container 120 or for an aggregate of the containers 120 in a namespace and stored in the infrastructure configuration repository 110. The configuration specifies resource allocations, limits, and/or parameters for the container 120, pod 118, or namespace. For example, the configuration may specify a CPU allocation request, a CPU limits, a memory allocation request, a memory limit, etc. Based on the configuration, the application 122 hosted within the container 120 and managed by the pod 118 may be assigned resources. A container 120 may only be scheduled on a node 116 that has more resources than the resource request in the configuration. A resource limit cannot be lower than the resource request.

CPU resources may be defined in millicores. If a container 120 needs two full cores to run, a value “2000m” would be provided for the CPU allocation request. If the container 120 only needs a quarter of a core, the CPU allocation request would have a value of “250m”. CPU resources are considered to be a compressible resource. If an application 122 causes the container 120 to hit a CPU limit, the cluster controller 104 throttles the container 120, which restricts the CPU resources and can reduce the performance of the application 122. In some embodiments, memory resources are defined based on a mebibyte value (which equals a megabyte). Unlike CPU resources, memory is not compressed by the cluster controller 104. Because there is no way to throttle memory usage, if a container 120 exceeds its memory limit, the container 120 will be terminated by the cluster controller 104. In some embodiments, the cluster controller 104 may instantiate a replacement container for the terminated container 120.

In some embodiments, the metric collector 112 aggregates peak resource usage by the containers 120 or pods 118 and the resource adjustor 114 dynamically adjusts the configuration to change the resource requests and limits based on the peak resource usage. Because the application 122 may be a legacy application that was designed for direct execution by an operating system, as opposed to being hosted within the container hosting environment 102, the application 122 may not be designed to efficiently utilize resources provided by the container hosting environment 102 to the pod 118 and the container 120. This situation can lead to overprovisioning of resources that the application 122 never uses and/or under provisioning of resources such that the application 122 experiences degraded performance.

In some instances, the resource needs of the application 122 may not be known since the application 122 is newly hosted by the container hosting environment 102. Deployment of an application 122 in a container 120 with unspecified requests and limits can result in out of memory (OOM) issues, CPU starvation, pod or container eviction, and/or financial waste. In an OOM situation a node 116 could die of memory starvation affecting stability of the cluster 106. For example, an application 122 with a memory leak could cause an OOM issue. In a CPU starvation scenario, applications will get slower because they must share a limited amount of CPU resources. An application 122 consuming an excessive amount of CPU resources could affect all applications 122 on the same node 116. Pod 118 or container 120 eviction can occur when a node 116 lacks sufficient resources. A node 116 may start an eviction process to terminate pods 118 or containers 120, starting with pods 118 or containers 120 without resource requests. A pod 118 or container 120 that is operating fine without requests and limits is likely overprovisioned, resulting in spending money on resources that are never used.

Rather than not specifying requests or limits, the container 120 for an application 122 with unknown resource requirements may be assigned an initial level of resources in its configuration. The resource adjustor 114 can dynamically adjust the initial configuration to change the resource requests and limits over time based on recorded values for peak resource usage. In some embodiments, initial resource requests and limits values are set based on information from the vendor of the application 122 to meet forecast peak demand with a full subscriber base. These numbers will be used to derive a ratio of peak demand to surge demand. However, if a vendor does not specify request and limits, default values may be applied. In one example, the resource provisions for the container 120 of a newly hosted application 122 may be assigned based on resources assigned to similar applications. In another example, the initial configuration may provide an overprovisioning of resources compared to similar applications and the resource adjustor 114 may dynamically adjust the resources downward over time. In yet another example, a namespace, pod 118 or container 120 may be allowed to operate for one cycle without requests or limits and the initial values for requests and limits may be defined based on observed peak resource utilization for that cycle. For example, the request may be set to three times the peak usage during the previous cycle and limits may be set to two times the request.

### Other

Requests and limits can be defined per-container or per-namespace. When defined for a namespace, the request and limits values are part of a namespace resource quota, which bounds the number of resources all of the pods 118 and containers 120 in a given namespace can consume. For a deployment, it is best practice to also define the resource requests and limits for the individual pods 118 or containers 120 that make up the deployment. For simplicity, the following example assigns resource requests and limits at the namespace level.

Once a namespace is created, a namespace resource quota can be defined in a configuration (i.e., manifest file) for CPU and memory resources and the configuration may be stored in the infrastructure configuration repository 110. The namespace resource quota may be applied to the cluster 106 using a “kubectl” command. Pods 118 and containers 120 may be created within the namespace and separate configurations may be used to assign CPU and memory resource requests and limits, such as by using the kubectl command. After the namespace, pod 118, or container 120 has been deployed for at least one tine interval, the CPU and memory resources actually used may be retrieved using the kubectl command.

In some embodiments, the metric collector 112 is a time series database integrated into the cluster deployment. The metric collector 112 stores time series entries for resource usage in the data store 113. Example time series database products include Prometheus and influxdb. The time series resource usage metrics may be stored at the namespace level, the pod level, and/or the container level.

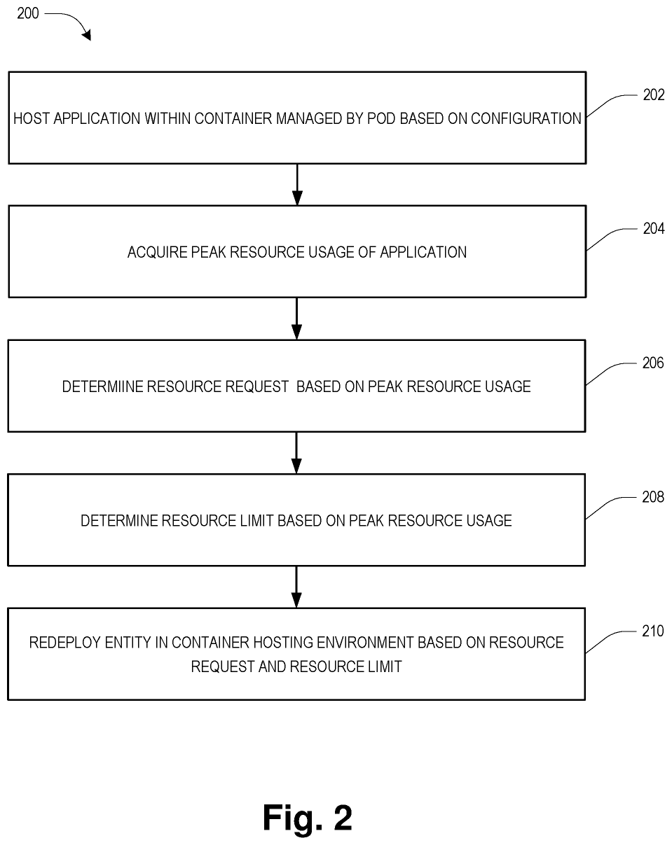

FIG. 2 illustrates an example of a method 200 for determining resource requests and limits within a cloud-scale hosting environment (such as a container hosting environment 102). At 202, an application 122 (e.g., a legacy application such as a Java application) may be hosted within a container 120 of a container hosting environment 102.

At 204, peak resource usage of the application 122 is acquired. The peak resource usage may be peak processor usage (e.g., CPU usage), peak memory usage, or both. In some embodiments, the peak resource usage statistics for the application 122 may be aggregated with usage statistics for other applications, containers 120, or pods 118 and aggregated at the container 120 level, the pod 118 level, and/or the namespace level.

At 206, a resource request is determined based on the peak resource usage. The resource request may be determined for any level of the aggregation hierarchy. For example, a first resource request may be determined at the namespace level, second resource requests may be determined for pods 118 in the namespace, and third resource requests may be determined for containers 120 in the pods 118.

At 208, a resource limit is determined based on the peak resource usage. The resource limit may be determined for an entity at any level of the aggregation hierarchy. For example, a first resource limit may be determined at the namespace level, second resource limits may be determined for pods 118 in the namespace, and third resource limits may be determined for containers 120 in the pods 118. Separate requests and limits may be calculated for processor usage and memory usage.

At 210, an entity in the container hosting environment 102 is redeployed based on the resource request and the resource limit. The entity may be a container 120, a pod 118, or a namespace. Redeploying the entity may include modifying a configuration associated with the entity, which may automatically trigger the redeployment. In some embodiments, the configuration for the entity (namespace, pod 118, or container 120) is stored in the infrastructure configuration repository 110. During the next execution time interval, the infrastructure manager 108 identifies the modified configuration (e.g., based on version number) and informs the cluster controller 104 to change the allocated resources.

In some embodiments, a resource request for increasing resource demand (e.g., CPU or memory) may be adjusted based on the formula:

$${R}_{NEW} = {R}_{PREV} + ( {m}^{*} ( D - {R}_{PREV} ) ) ,$$

where R_{NEW} is the new resource limit, R_{PREV} is the previous resource request, D is the peak busy hour resource usage (demand) over the interval by the application 122, container 120, or pod 118 (depending on aggregation hierarchy level), and m is a multiplier applied to the difference between R_{PREV} and D to determine an adjustment factor.

In the case where the difference between R_{PREV} and D is positive (increasing demand), the multiplier, m, may be less than one to affect the ramp rate for request increases and account for forecasting errors. Assuming a previous request value of R_{NEW}=1000 units (e.g., CPU or memory units), a measured demand of D=1200 units, and a multiplier of 0.1, the value of the new resource request is R_{NEW}=1000+(0.1*(1200−1000))=1020 units.

In the case where the difference between R_{PREV} and D is negative (decreasing demand), the multiplier, m, may have a different value than for an increasing demand to provide a smoothing factor that limits the ramp rate for resource decreases to avoid resource starving. Assuming a previous request value of R_{NEW}=1000 units, a measured demand of D=800 units, and a smoothing factor of 0.5, the value of the new resource limit is R_{NEW}=1000+(0.5*(800−1000))=900 units.

Note that resource request increases result in higher cost, while resource request decreases reduce cost. In some embodiments, the multiplier for decreasing demand allows for more rapid resource request decreases than the multiplier for increasing demand in an overall attempt to reduce costs by favoring resource request decreases and throttling resource request increases.

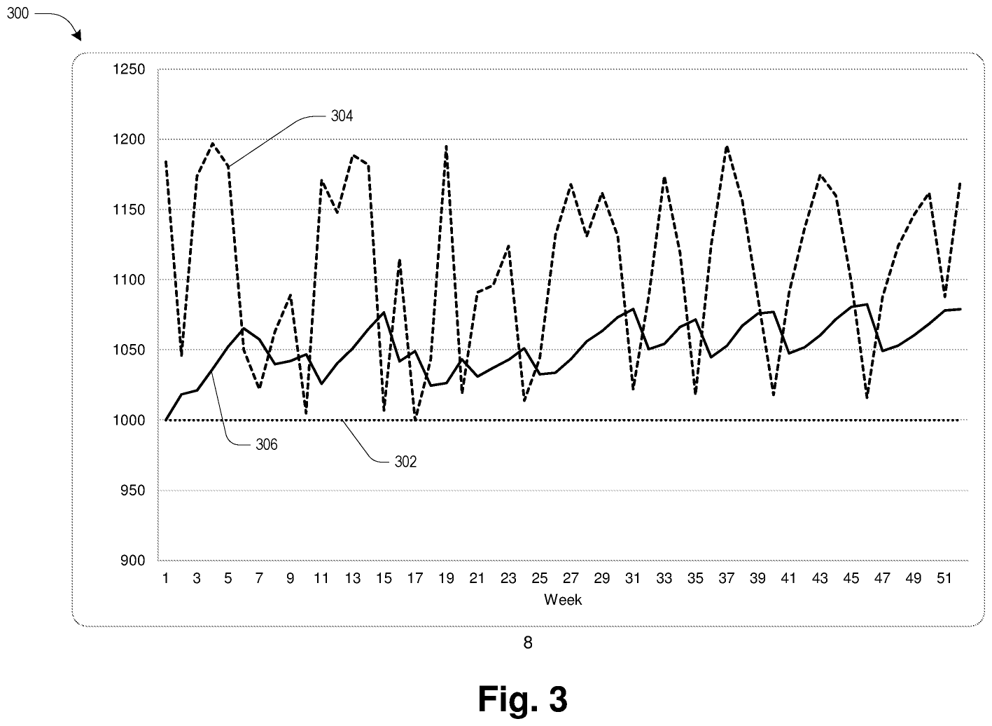

FIG. 3 is a diagram illustrating resource requests for an entity (namespace, pod 118, or container 120) over time. The line 302 represents the initial resource request and remains static over time. The line 304 represents the observed peak resource demand for a given observation interval (e.g., one week). The line 306 represents the adjusted resource request implemented for the subsequent observation interval. Note that for periods of increasing demand, the line 306 increases according a first rate (e.g., 10%) based on the multiplier, m, but for decreasing demand the line 306 decreases according to a second rate (e.g., 25%), greater than the first rate to favor cost savings. Request increases are implemented more slowly to limit cost increases and request decreases are implemented more quickly to realize cost decreases.

In some embodiments, resource limits are adjusted based on the modified resource requests. Different resource limits may be determined for different levels of the aggregation hierarchy.

In some embodiments, a resource limit at the container 120 level may be:

$${L}_{NEW} = {n}^{*} {R}_{NEW} ,$$

where n is a surge multiplier representing a ratio of surge demand to peak demand. In some embodiments, a surge is defined is a special event that results in a spike of activity, such as a launch event, a marketing event, a sports event, or some other event that can cause higher than normal activity. The surge multiplier may be two times the request in one example.

In some embodiments, a resource limit at the pod 118 level may be:

$${L}_{NEW} = {p}^{*} \sum {R}_{NEW} ,$$

where Σ represents the sum of the modified resource requests for the containers 120 in the pod and p is a surge multiplier for the pod 118, which may differ from the surge ratio for the container 120. In the case where the applications 122 in the containers 120 are tightly coupled in terms of resource usage (i.e., the applications 122 tend to track each other in usage trends), the value of p may the same as n. However, if the applications 122 are not coupled in terms of usage trends, it is less likely that all applications 122 will experience a surge at the same time, and the value of p can be less than n.

At the namespace level, it is even less likely that the applications 122, containers 120, and pods 118 will surge at the same time. In some embodiments, a surge factor, T, may be defined that assumes a value for surge coupling in the namespace. The surge factor may be determined based on history or engineering analysis, for example. A surge factor of 0.30 represents the assumption that only 30% of the applications 122, containers 120, or pods 118 will surge at the same time. Thus, the resource limit at the namespace level may be:

$${AL}_{NEW} = \sum {R}_{NEW} + \sum {( {L}_{NEW} - {R}_{NEW} )}^{*} T ,$$

where AL_{NEW} is the new aggregate limit for the namespace, ΣR_{NEW} is the sum of the resource requests for the entities in the namespace, for example, the sum of all container 120 resource requests, L_{NEW}−R_{NEW} is the difference between the new resource limit and the new resource request for an entity, which us summed across all the entities in the namespace, and T is the surge factor applied to the sum of the differences to generate an adjustment factor.

In one example, assume the aggregate resource requests equals 200 units (e.g., CPU or memory units), the aggregate of the adjusted limits is 200 units, and the surge factor is 0.3, the modified aggregate limit for the namespace is:

$${AL}_{NEW} = 200 + {( 400 - 200 )}^{*} 0.3 = 200 + 60 = 260 units .$$

Limit adjustments in the downward direction may be limited. To prevent rapid down adjustments from impacting workload stability, a limiter will be applied to decreases in aggregate resource limit values. For example, the maximum reduction in an aggregate resource limit may be limited to 25% of the previous value of the aggregate resource limit.

Using the surge factor to reduce the aggregate limit saves cost since the resources provisioned for the namespace are less than the aggregate for the entities in the namespace.

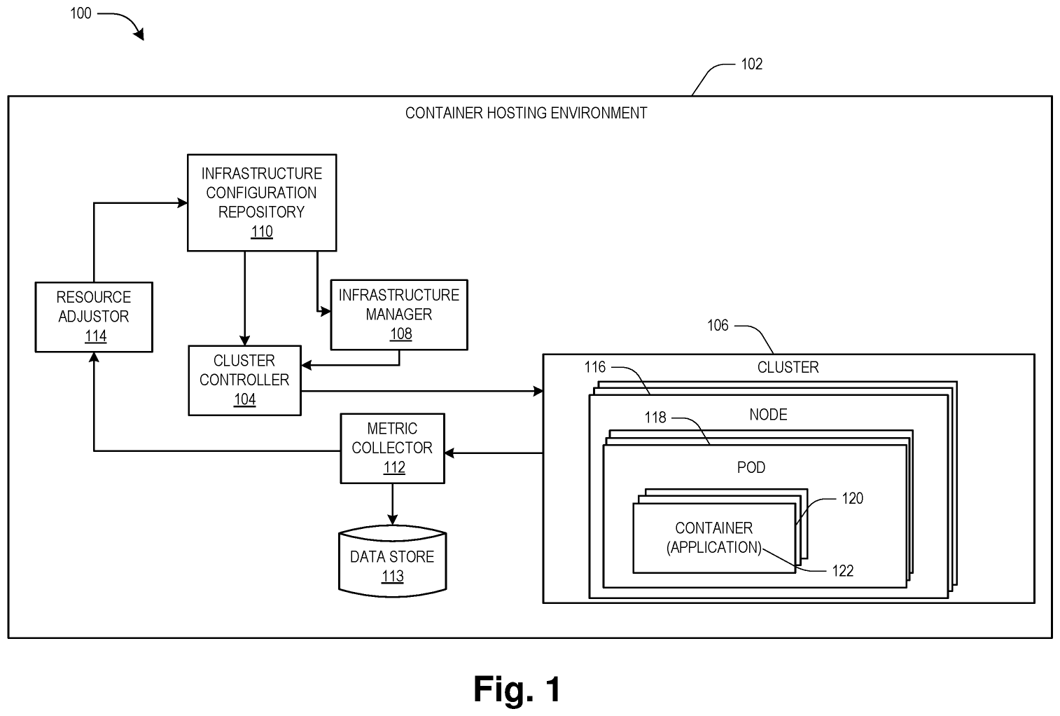

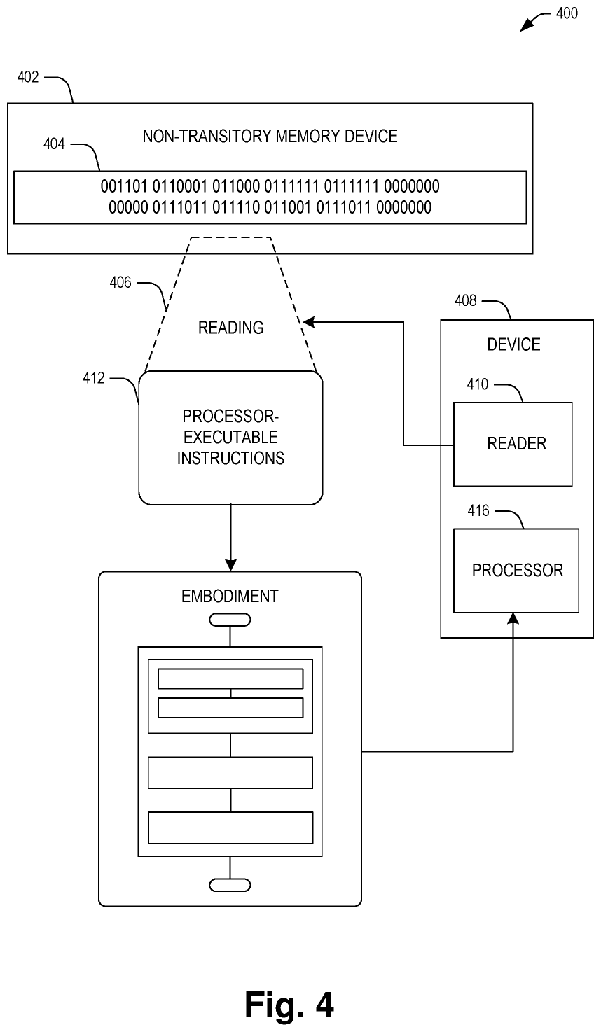

FIG. 4 is an illustration of a scenario 400 involving an example non-transitory machine readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 402 stores computer-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example method 200 of FIG. 2, for example. In some embodiments, the processor-executable instructions 412 are configured to cause implementation of a system, such as at least some of the system 100 of FIG. 1.

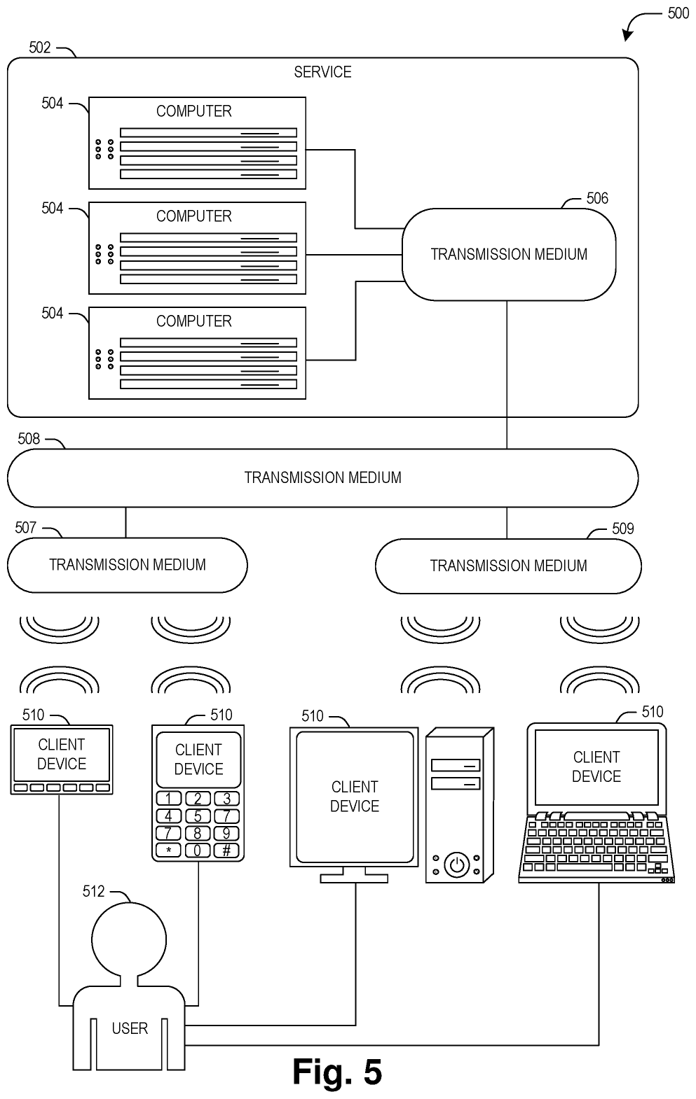

FIG. 5 is an interaction diagram of a scenario 500 illustrating a service 502 provided by a set of computers 504 to a set of client devices 510 via various types of transmission mediums. The computers 504 and/or client devices 510 may be capable of transmitting, receiving, processing, and/or storing many types of signals, such as in memory as physical memory states.

The computers 504 of the service 502 may be communicatively coupled together, such as for exchange of communications using a transmission medium 506. The transmission medium 506 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 502.

Likewise, the transmission medium 506 may comprise one or more sub-networks, such as may employ different architectures, may be compliant or compatible with differing protocols and/or may interoperate within the transmission medium 506. Additionally, various types of transmission medium 506 may be interconnected (e.g., a router may provide a link between otherwise separate and independent transmission medium 506).

In scenario 500 of FIG. 5, the transmission medium 506 of the service 502 is connected to a transmission medium 508 that allows the service 502 to exchange data with other services 502 and/or client devices 510. The transmission medium 508 may encompass various combinations of devices with varying levels of distribution and exposure, such as a public wide-area network and/or a private network (e.g., a virtual private network (VPN) of a distributed enterprise).

In the scenario 500 of FIG. 5, the service 502 may be accessed via the transmission medium 508 by a user 512 of one or more client devices 510, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 510 may communicate with the service 502 via various communicative couplings to the transmission medium 508. As a first such example, one or more client devices 510 may comprise a cellular communicator and may communicate with the service 502 by connecting to the transmission medium 508 via a transmission medium 507 provided by a cellular provider. As a second such example, one or more client devices 510 may communicate with the service 502 by connecting to the transmission medium 508 via a transmission medium 509 provided by a location such as the user's home or workplace (e.g., a WiFi (Institute of Electrical and Electronics Engineers (IEEE) Standard 702.11) network or a Bluetooth (IEEE Standard 702.15.1) personal area network). In this manner, the computers 504 and the client devices 510 may communicate over various types of transmission mediums.

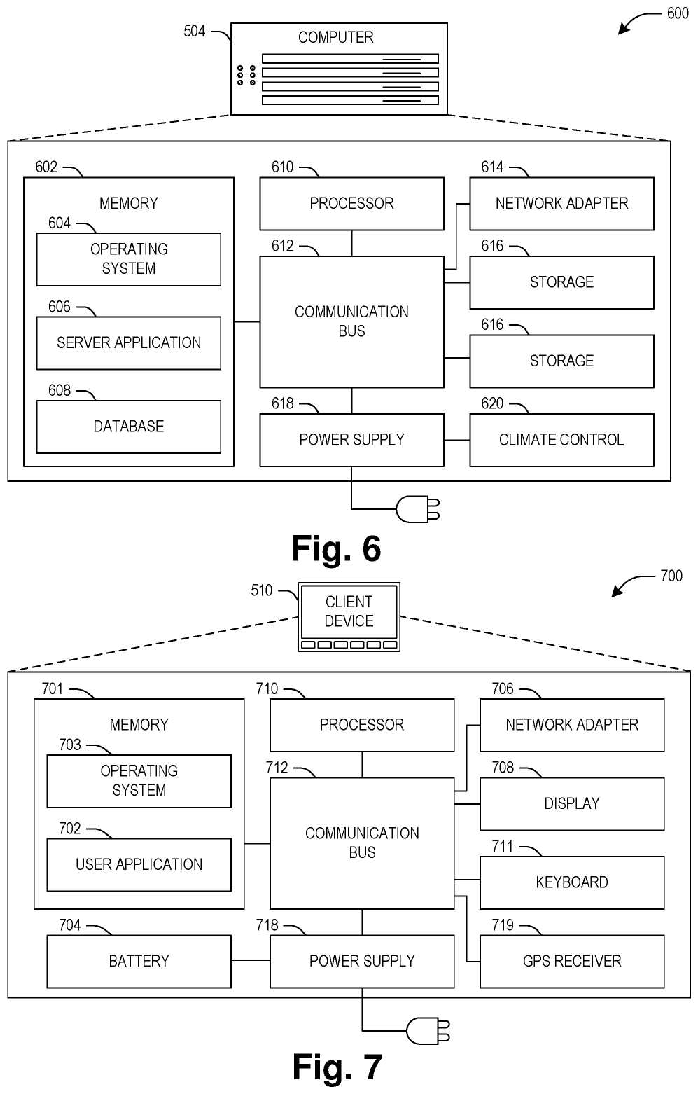

FIG. 6 presents a schematic architecture diagram 600 of a computer 504 that may utilize at least a portion of the techniques provided herein. Such a computer 504 may vary widely in configuration or capabilities, alone or in conjunction with other computers, in order to provide a service such as the service 502.

The computer 504 may comprise one or more processors 610 that process instructions. The one or more processors 610 may optionally include a plurality of cores; one or more coprocessors, such as a mathematics coprocessor or an integrated graphical processing unit (GPU); and/or one or more layers of local cache memory. The computer 504 may comprise memory 602 storing various forms of applications, such as an operating system 604; one or more computer applications 606; and/or various forms of data, such as a database 608 or a file system. The computer 504 may comprise a variety of peripheral components, such as a wired and/or wireless network adapter 614 connectible to a local area network and/or wide area network; one or more storage components 616, such as a hard disk drive, a solid-state storage device (SSD), a flash memory device, and/or a magnetic and/or optical disk reader.

The computer 504 may comprise a mainboard featuring one or more communication buses 612 that interconnect the processor 610, the memory 602, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 612 may interconnect the computer 504 with at least one other computer. Other components that may optionally be included with the computer 504 (though not shown in the schematic architecture diagram 600 of FIG. 6) include a display; a display adapter, such as a graphical processing unit (GPU); input peripherals, such as a keyboard and/or mouse; and a flash memory device that may store a basic input/output system (BIOS) routine that facilitates booting the computer 504 to a state of readiness.

The computer 504 may operate in various physical enclosures, such as a desktop or tower, and/or may be integrated with a display as an “all-in-one” device. The computer 504 may be mounted horizontally and/or in a cabinet or rack, and/or may simply comprise an interconnected set of components. The computer 504 may comprise a dedicated and/or shared power supply 618 that supplies and/or regulates power for the other components. The computer 504 may provide power to and/or receive power from another computer and/or other devices. The computer 504 may comprise a shared and/or dedicated climate control unit 620 that regulates climate properties, such as temperature, humidity, and/or airflow. Many such computers 504 may be configured and/or adapted to utilize at least a portion of the techniques presented herein.

FIG. 7 presents a schematic architecture diagram 700 of a client device 510 whereupon at least a portion of the techniques presented herein may be implemented. Such a client device 510 may vary widely in configuration or capabilities, in order to provide a variety of functionality to a user such as the user 512. The client device 510 may be provided in a variety of form factors, such as a desktop or tower workstation; an “all-in-one” device integrated with a display 708; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 510 may serve the user in a variety of roles, such as a workstation, kiosk, media player, gaming device, and/or appliance.

The client device 510 may comprise one or more processors 710 that process instructions. The one or more processors 710 may optionally include a plurality of cores; one or more coprocessors, such as a mathematics coprocessor or an integrated graphical processing unit (GPU); and/or one or more layers of local cache memory. The client device 510 may comprise memory 701 storing various forms of applications, such as an operating system 703; one or more user applications 702, such as document applications, media applications, file and/or data access applications, communication applications such as web browsers and/or email clients, utilities, and/or games; and/or drivers for various peripherals. The client device 510 may comprise a variety of peripheral components, such as a wired and/or wireless network adapter 706 connectible to a local area network and/or wide area network; one or more output components, such as a display 708 coupled with a display adapter (optionally including a graphical processing unit (GPU)), a sound adapter coupled with a speaker, and/or a printer; input devices for receiving input from the user, such as a keyboard 711, a mouse, a microphone, a camera, and/or a touch-sensitive component of the display 708; and/or environmental sensors, such as a global positioning system (GPS) receiver 719 that detects the location, velocity, and/or acceleration of the client device 510, a compass, accelerometer, and/or gyroscope that detects a physical orientation of the client device 510. Other components that may optionally be included with the client device 510 (though not shown in the schematic architecture diagram 700 of FIG. 7) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 510 to a state of readiness; and a climate control unit that regulates climate properties, such as temperature, humidity, and airflow.

The client device 510 may comprise a mainboard featuring one or more communication buses 712 that interconnect the processor 710, the memory 701, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 510 may comprise a dedicated and/or shared power supply 718 that supplies and/or regulates power for other components, and/or a battery 704 that stores power for use while the client device 510 is not connected to a power source via the power supply 718. The client device 510 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed:

1. A method, comprising:
hosting a first application within a first container of a container hosting environment;
acquiring a first peak resource usage for the first application;
determining a first resource request for the first application based on the first peak resource usage;
determining a first resource limit for the first application based on the first peak resource usage; and
redeploying an entity in the container hosting environment based on the first resource request and the first resource limit.

2. The method of claim 1, wherein redeploying the entity based on the first resource request and the first resource limit comprises:
modifying a first configuration associated with the entity.

3. The method of claim 1, wherein redeploying the entity based on the first resource request and the first resource limit comprises:
redeploying at least one of the first container, a first pod hosting the first container, or a namespace comprising the first container.

4. The method of claim 1, comprising:
hosting a second application within a second container of the container hosting environment;
acquiring a second peak resource usage for the second application;
determining a second resource request for the second application based on the second peak resource usage;
determining a second resource limit for the second application based on the second peak resource usage; and
aggregating the first resource request and the second resource request to generate an aggregate resource request, wherein:
redeploying the entity comprises redeploying the entity based on the aggregate resource request.

5. The method of claim 4, comprising:
generating an aggregate resource limit based on the aggregate resource request, wherein:
redeploying the entity comprises redeploying the entity based on the aggregate resource limit.

6. The method of claim 5, wherein generating the aggregate resource limit comprises:
applying a surge multiplier to the aggregate resource request to generate the aggregate resource limit.

7. The method of claim 5, wherein generating the aggregate resource limit comprises:
determining a first difference between the first resource limit and the first resource request;
determining a second difference between the second resource limit and the second resource request;
applying a surge ratio to a sum of the first difference and the second difference to generate an adjustment factor; and
adding a sum of the first resource request and the second resource request to the adjustment factor to generate the aggregate resource limit.

8. The method of claim 5 wherein generating the aggregate resource limit comprises:
limiting decreases in the aggregate resource limit to a predetermined percentage of a previous value of the aggregate resource limit.

9. The method of claim 1, wherein determining the first resource request comprises:
determining a difference between the first peak resource usage and a previous value of the first resource request;
applying a multiplier to the difference to determine an adjustment factor; and
applying the adjustment factor to the previous value of the first resource request to determine the first resource request.

10. The method of claim 9, wherein applying the multiplier comprises:
applying a first value of the multiplier responsive to the difference having a positive value; and
applying a second value of the multiplier greater than the first value responsive to the difference having a negative value.

11. The method of claim 1, wherein determining the first resource limit for the first application comprises:
applying a surge multiplier to the first peak resource usage to determine the first resource limit.

12. The method of claim 1, wherein redeploying the entity in the container hosting environment comprises:
redeploying at least one of a container, a pod, or a namespace.

13. A computing device comprising:
one or more processors configured to:
host a first application within a first container of a container hosting environment;
acquire a first peak resource usage for the first application;
determine a first resource request for the first application based on the first peak resource usage;
determine a first resource limit for the first application based on the first peak resource usage; and
redeploy an entity in the container hosting environment based on the first resource request and the first resource limit.

14. The computing device of claim 13, wherein the one or more processors are further configured to:
host a second application within a second container of the container hosting environment;
acquire a second peak resource usage for the second application;
determine a second resource request for the second application based on the second peak resource usage;
determine a second resource limit for the second application based on the second peak resource usage; and
aggregate the first resource request and the second resource request to generate an aggregate resource request, wherein:
redeploying the entity comprises redeploying the entity based on the aggregate resource request.

15. The computing device of claim 14, wherein the one or more processors are further configured to:
generate an aggregate resource limit based on the aggregate resource request; and
redeploy the entity by redeploying the entity based on the aggregate resource limit.

16. The computing device of claim 13, wherein the one or more processors are further configured to determine the first resource request by:
determining a difference between the first peak resource usage and a previous value of the first resource request;
applying a multiplier to the difference to determine an adjustment factor; and
applying the adjustment factor to the previous value of the first resource request to determine the first resource request.

17. A non-transitory computer-readable medium storing instructions that when executed facilitate performance of operations comprising:
hosting a first application within a first container of a container hosting environment;
acquiring a first peak resource usage for the first application;
determining a first resource request for the first application based on the first peak resource usage;
determining a first resource limit for the first application based on the first peak resource usage; and
modifying a configuration of an entity for hosting the entity in the container hosting environment based on the first resource request and the first resource limit to generate a modified configuration.

18. The non-transitory computer-readable medium of claim 17, wherein the operations comprise:
hosting a second application within a second container of the container hosting environment;
acquiring a second peak resource usage for the second application;
determining a second resource request for the second application based on the second peak resource usage;
determining a second resource limit for the second application based on the second peak resource usage; and
aggregating the first resource request and the second resource request to generate an aggregate resource request, wherein:
modifying the configuration comprises modifying the configuration based on the aggregate resource request.

19. The non-transitory computer-readable medium of claim 18, wherein the operations comprise:
generating an aggregate resource limit based on the aggregate resource request, wherein:
modifying the configuration comprises modifying the configuration based on the aggregate resource limit.

20. The non-transitory computer-readable medium of claim 19, wherein generating the aggregate resource limit comprises:
determining a first difference between the first resource limit and the first resource request;
determining a second difference between the second resource limit and the second resource request;
applying a surge ratio to a sum of the first difference and the second difference to generate an adjustment factor; and
adding a sum of the first resource request and the second resource request to the adjustment factor to generate the aggregate resource limit.
